(19) United States
(12) Patent Application Publication
(10) Pub. No.: US 2015/0280429 A1
(43) Pub. Date: Oct. 1, 2015

(54) COMMUNICATION APPARATUS AND ELECTRONIC DEVICE

(71) Applicant: NEC TOKIN CORPORATION, Miyagi (JP)

(72) Inventors: Kazumasa Makita, Sendai-shi (JP); Junetsu Urata, Sendai-shi (JP); Yuichi Sakurai, Sendai-shi (JP); Koji Sato, Sendai-shi (JP); Masashi Mori, Sendai-shi (JP); Masaki Kurimoto, Sendai-shi (JP)

(73) Assignee: NEC TOKIN CORPORATION, Sendai-shi, Miyagi (JP)

(21) Appl. No.: 14/646,482

(22) PCT Filed: Feb. 7, 2014
(86) PCT No.: PCT/JP2014/052933

§ 371 Date: May 21, 2015

(30) Foreign Application Priority Data
May 20, 2013 (JP) 2013-105858
Aug. 30, 2013 (JP) 2013-179045

(51) Int. Cl. H02H 9/04; H02J 17/00

(52) U.S. Cl. CPC H02H 9/04; H02J 17/00

(57) ABSTRACT

A communication apparatus includes: a communication antenna, a communication unit which can transmit and receive signals, a switch connected between the communication antenna and the communication unit and composed of a semiconductor switch, a switch control unit, and a high-voltage output means. The switch, when receiving a connection command signal causes the communication unit to be electrically connected with the communication antenna, and when not receiving the signal cuts them off. The switch control unit outputs the signal to the switch under prescribed conditions, and stops the signal when overvoltage applied to the communication unit is detected. The high-voltage output means, connected between the switch control unit and the switch, sets voltage of the signal received from the switch control unit to a voltage at which the communication unit in a transmitting mode would not be cut off from the communication antenna, and outputs the voltage to the switch.

### TECHNICAL FIELD

This invention relates to a communication device comprising a communication antenna and a communication section connected to the communication antenna.

### BACKGROUND ART

Recently, non-contact electric power transmission to a communication device is practically used. For example, when a communication device receives electric power via a communication antenna, the communication antenna during reception of the electric power might generate an overvoltage, or a voltage which exceeds an endurable voltage of a communication section. In such a case, the communication section might be damaged by the overvoltage. Similar problem may also be caused when a communication device without a non-contact electric power transmission function is placed in the vicinity of a device during transmission of the electric power. In order to avoid such problems, a communication device needs to include structure for protecting its communication section from the overvoltage.

For example, each of Patent Document 1 and Patent Document 2 discloses a communication device which is capable of receiving the electric power in a non-contact manner and which includes structure for protecting its communication section from the overvoltage.

The reception device (communication device) of Patent Document 1 comprises a coil (communication antenna) and a communication control integrated circuit (communication section), wherein the communication antenna is used for communication with a transmission device, and the communication section is connected to the communication antenna. The communication antenna is also used for the reception of the electric power from the transmission device. The communication device further comprises an input connection circuit (protection circuit). The protection circuit is provided between the communication antenna and the communication section. When a voltage in the communication antenna is elevated because of the reception of the electric power, the protection circuit works to lower a voltage applied to the communication section. As a result, the communication section is protected from an overvoltage generated because of the reception of the electric power.

The protection circuit of Patent Document 1 lowers the voltage applied to the communication section by leaking a part of electric current to the ground, wherein the electric current is generated because of the non-contact electric power transmission. Accordingly, a part of the transmitted electric power is lost.

The module (communication device) of Patent Document 2 comprises an antenna (communication antenna) and a communication section, wherein the communication antenna is used for communication with an external device, and the communication section is connected to the communication antenna. The communication antenna is also used for the reception of the electric power from a primary device. The communication device further comprises a switch circuit (switch) and a switch control circuit (switch control section). The switch is provided between the communication antenna and the communication section. When the communication antenna has high electric power, the switch control section turns the switch into an OFF-state to electrically disconnect the communication section from the communication antenna. The switch under the OFF-state basically consumes no electric power. Accordingly, the communication section is prevented from the overvoltage while suppressing the consumption of the transmitted electric power.

### PRIOR ART DOCUMENTS

### Patent Document(s)

Patent Document 1: JP A 2011-172299
Patent Document 2: WO2012/090904

### SUMMARY OF INVENTION

### Technical Problem

The switch of Patent Document 2 is provided between the communication section and the communication antenna. Accordingly, if the switch during communication is turned into the OFF-state in error, the communication is stopped. There is therefore a requirement for a communication device which can reliably maintain its communication state while securely protecting its communication section.

It is therefore an object of the present invention to provide a communication device which can satisfy this requirement.

### Solution to Problem

A switch provided between a communication section and a communication antenna is required to be durable for repeated on/off and not to consume large electric power upon being turned on/off. The switch is therefore preferred to be formed by using a semiconductor switch such as a metal-oxide-semiconductor field-effect transistor (MOSFET). When the MOSFET is used, the source and the drain of the MOSFET may be connected between the communication section and the communication antenna. In this structure, the switch can be turned into an ON-state when a connection command signal, which has a voltage not smaller than a predetermined value, is applied to the gate, and the switch can be turned into the OFF-state when the connection command signal is not applied to the gate.

However, in some cases, the source and the drain has a large voltage generated not only because of the reception of the electric power but also because of communication by the communication section. In particular, when the communication section transmits a signal, a large voltage might be generated. If electric potential difference between the gate and the source or between the gate and the drain becomes small, the switch is not properly turned into the ON-state. In order to reliably maintain the communication state, or to properly turn the switch into the ON-state, the voltage of the connection command signal needs to be sufficiently larger than the voltage generated because of the signal transmission of the communication section.

The present invention therefore provides a communication device based on the aforementioned consideration, wherein the communication device can apply the connection command signal of proper voltage to the semiconductor switch while considering the voltage generated during the signal transmission of the communication section. Specifically, the present invention provides a communication device and an electronic apparatus described below.

First aspect of the present invention provides a communication device comprising a communication antenna, a communication section, a switch, a switch control section and a high voltage output part. The communication section is capable of transmitting and receiving a signal via the communication antenna. The switch is formed of a semiconductor switch. The switch is connected between the communication antenna and the communication section. The switch electrically connects the communication section with the communication antenna when receiving a connection command signal. The switch electrically disconnects the communication section from the communication antenna when not receiving the connection command signal. The switch control section outputs the connection command signal toward the switch under a specific condition. The switch control section stops the connection command signal when detecting in advance that an overvoltage is to be applied to the communication section. The high voltage output part is connected between the switch control section and the switch. The high voltage output part converts a voltage of the connection command signal, which is received from the switch control section and is to be output to the switch, into another voltage that keeps the communication section in a signal transmitting state from being electrically disconnected from the communication antenna.

Second aspect of the present invention provides an electronic apparatus comprising the communication device according to the first aspect.

### Advantageous Effects of Invention

The switch control section according to the present invention stops the connection command signal when detecting in advance that the overvoltage is to be applied to the communication section. The communication section is therefore securely protected. Moreover, the high voltage output part according to the present invention converts the voltage of the connection command signal to be output to the switch into the other voltage that keeps the communication section in the signal transmitting state from being electrically disconnected from the communication antenna. Accordingly, even if the voltage in the communication antenna is raised, for example, by the signal transmission from the communication section, the switch is kept in the ON-state. The signal transmitting state can be more reliably maintained.

An appreciation of the objectives of the present invention and a more complete understanding of its structure may be had by studying the following description of the preferred embodiment and by referring to the accompanying drawings.

### BRIEF DESCRIPTION OF DRAWINGS

FIG. 1 is a block diagram schematically showing a communication device according to a first embodiment of the present invention.

FIG. 2 is a circuit diagram showing an example of a switch of the communication device of FIG. 1.

FIG. 3 is a view showing action of the switch of FIG. 1.

FIG. 4 is a block diagram schematically showing a communication device according to a second embodiment of the present invention.

FIG. 5 is a circuit diagram showing examples of a switch and an additional switch (the part enclosed by dashed line A) of the communication device of FIG. 4.

FIG. 6 is a view showing action of the switch and the additional switch of FIG. 4 under a condition where a communication section of the communication device of FIG. 4 is not in a signal transmitting state.

FIG. 7 is a view showing action of the switch and the additional switch of FIG. 4 under a condition where the communication section of the communication device of FIG. 4 is in the signal transmitting state.

FIG. 8 is a block diagram schematically showing a communication device according to a third embodiment of the present invention.

FIG. 9 is a view showing action of a switch of the communication device of FIG. 8.

FIG. 10 is a block diagram schematically showing a communication device according to a forth embodiment of the present invention.

FIG. 11 is a block diagram schematically showing a communication device according to a fifth embodiment of the present invention.

FIG. 12 is a circuit diagram showing an example of a switch control section of the communication device of FIG. 11.

FIG. 13 is a view showing action of a switch and an auxiliary switch of the communication device of FIG. 11 under a condition where a communication section of the communication device of FIG. 11 is not in the signal transmitting state.

FIG. 14 is a view showing the action of the switch of FIG. 11.

FIG. 15 is a view showing the action of the auxiliary switch of FIG. 11.

FIG. 16 is a timing chart showing the action of the switch and the auxiliary switch of FIG. 11.

FIG. 17 is a block diagram schematically showing a communication device according to a sixth embodiment of the present invention.

FIG. 18 is a view showing action of a switch of the communication device of FIG. 17.

FIG. 19 is a block diagram schematically showing a communication device according to a seventh embodiment of the present invention.

FIG. 20 is a circuit diagram showing an example of a high voltage output circuit of the communication device of FIG. 19.

FIG. 21 is a block diagram showing further detail of an impedance matching section of the communication device of FIG. 19, wherein a part of a switch and a part of a communication section of the communication device are schematically illustrated.

FIG. 22 is a block diagram schematically showing a communication device according to an eighth embodiment of the present invention.

FIG. 23 is a block diagram schematically showing a communication device according to a ninth embodiment of the present invention.

### DESCRIPTION OF EMBODIMENTS

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### First Embodiment

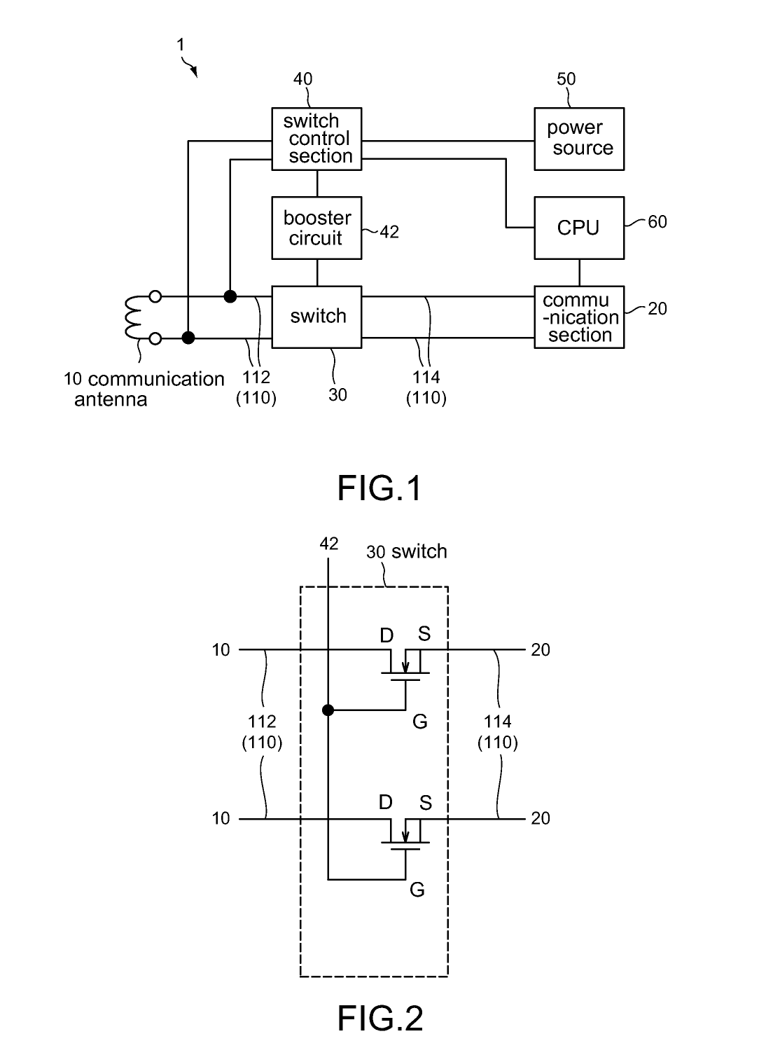

As shown in FIG. 1, a communication device 1 according to a first embodiment of the present invention comprises a communication antenna 10, a communication section 20, a switch 30, a switch control section 40, a booster circuit (high voltage output part) 42, a power source 50 and a central processing unit (CPU) 60.

The communication antenna 10 is connected to the communication section 20 via two signal lines 110. The communication section 20 is capable of communicating an external device (not shown) via the communication antenna 10. In detail, the communication section 20 according to the present embodiment is capable of transmitting a signal, namely, a transmission signal, to the external device via the communication antenna 10 and is capable of receiving a signal, namely, a reception signal, from the external device.

The communication antenna 10 is, for example, a loop antenna which can be magnetically coupled with an external antenna (not shown) of the external device. The loop antenna may be provided with a magnetic body such as a soft magnetic sheet. The provision of the magnetic body to the loop antenna can improve the magnetic coupling between the communication antenna 10 and the external antenna. Moreover, the communication section 20 can be prevented from being affected by a magnetic field due to the external device.

The switch 30 is connected between the communication antenna 10 and the communication section 20. In other words, the switch 30 is proved on the signal lines 110. In detail, each of the signal lines 110 is formed of one of signal lines 112 which are connected to opposite ends of the communication antenna 10, respectively, and one of signal lines 114 which are connected to the communication section 20. The switch 30 is connected to the communication antenna 10 via the signal lines 112 and is connected to the communication section 20 via the signal lines 114.

The switch 30 may be connected the communication antenna 10 via an impedance matching circuit (not shown). The impedance matching circuit can reduce electric potential difference between the signal lines 112 and the signal lines 114.

As shown in FIG. 2, the switch 30 is formed of semiconductor switches. In detail, the switch 30 according to the present embodiment is formed of two n-type MOSFETs. For each MOSFET, the drain is connected to the signal line 112, and the source is connected to the signal line 114. For each MOSFET, the gate is connected to the booster circuit 42.

As described above, the source and the drain of each MOSFET of the switch 30 is connected to the signal line 110. Accordingly, when a signal, namely, a connection command signal, having a voltage sufficiently larger than another voltage of the signal line 110 is input to the gate, the drain and the source are electrically connected with each other. In other words, the switch 30 is turned into an ON-state. On the other hand, when the aforementioned connection command signal is not input to the gate, the drain and the source are electrically disconnected from each other. In other words, the switch 30 is turned into an OFF-state.

As can be seen from the above explanation, when receiving the connection command signal, the switch 30 is in the ON-state to electrically connect the communication section 20 with the communication antenna 10. Accordingly, transmission of the signal (transmission signal) by the communication section 20 and reception of the signal (reception signal) via the communication antenna 10 can be enabled. On the other hand, when not receiving the connection command signal, the switch 30 is in the OFF-state to electrically disconnect the communication section 20 from the communication antenna 10. Accordingly, the communication section 20 is prevented from an overvoltage.

As shown in FIG. 1, the switch control section 40 according to the present embodiment is connected to the communication antenna 10 in parallel to the switch 30. Moreover, the switch control section 40 is connected to the switch 30 via the booster circuit 42. As can be seen from this structure, the switch control section 40 is to output the aforementioned connection command signal toward the switch 30.

In detail, the switch control section 40 according to the present embodiment includes a rectifier circuit (not shown). Via the rectifier circuit, the switch control section 40 is capable of detecting a DC voltage (hereafter, referred to as “rectified voltage” or “detected voltage”) that is a voltage generated in the communication antenna 10 because of signal transmission/reception (including electric power reception) with use of the communication antenna 10. In other words, the switch control section 40 is capable of detecting the voltage of the reception signal (including the electric power reception signal) and the voltage of the transmission signal in the communication antenna 10 as the detected voltage.

The switch control section 40 outputs the connection command signal toward the switch 30 under a specific condition described later. Moreover, the switch control section 40 stops the connection command signal when detecting in advance that the overvoltage, or a predetermined voltage larger than the endurable voltage of the communication section 20, is to be applied to the communication section 20. When the switch control section 40 stops the connection command signal, the communication section 20 is electrically disconnected from the communication antenna 10 to be prevented from the overvoltage.

In particular, the switch control section 40 according to the present embodiment detects the overvoltage in advance depending on the detected voltage. In detail, when the detected voltage is not smaller than a predetermined value and smaller than the overvoltage, the switch control section 40 detects in advance that a voltage equal to or larger than the overvoltage is to be applied to the communication section 20. This predetermined value is larger than a voltage that is be generated in the communication antenna 10 because of the signal transmission by the communication section 20 via the communication antenna 10 and is smaller than the overvoltage. For example, the predetermined value is slightly smaller than the overvoltage.

The booster circuit 42 is connected between the switch control section 40 and the switch 30. As explained below, the booster circuit 42 converts a voltage of the connection command signal, which is received from the switch control section 40 and is to be output to the switch 30, into another voltage that keeps the communication section 20 in a signal transmitting state from being electrically disconnected from the communication antenna 10.

Referring to FIG. 2, a voltage is generated in the signal lines 110 because of the transmission signal from the communication section 20 and because of the reception signal from the communication antenna 10. In general, when the communication section 20 transmits the signal (i.e. when the communication section 20 is in the signal transmitting state), a large voltage tends to be generated in the signal lines 110. If electric potential difference between the voltage of the connection command signal output to the gate and the voltage of the signal lines 110 is small, the switch 30 might not be properly in the ON-state. In other words, in order to properly turn the switch 30 into the ON-state, the voltage of the connection command signal applied to the gate needs to be sufficiently larger than the voltage of the signal lines 110.

As described above, the booster circuit 42 sufficiently boosts the voltage of the connection command signal and applies it to the switch 30. In other words, the switch 30 is controlled by the boosted connection command signal. Accordingly, the switch 30 can be prevented from being turned into the OFF-state in error. The communication by the communication section 20 can be stably maintained while the communication section 20 is protected from the overvoltage.

Referring to FIG. 1, the power source 50 is a battery which supplies operating power to the switch control section 40. The illustrated power source 50 is directly connected only to the switch control section 40. However, the power source 50 may be also connected to the CPU 60 and the communication section 20. The power source 50 according to the present embodiment supplies the operating power to the booster circuit 42 via the switch control section 40. According to the present embodiment, the operating power supplied from the power source 50 is mainly consumed by the booster circuit 42. The booster circuit 42 boosts the voltage of the connection command signal by using the supplied operating power.

For example, when the supply voltage of the power source 50 is 3.3V and the voltage generated in the signal lines 110 is not larger than 3.3V, the voltage of the connection command signal output by the switch control section 40 may be boosted into 5V by the booster circuit 42 to be output to the switch 30.

The power source 50 does not need to be a battery. For example, a part of the electric power generated in the communication antenna 10 may be rectified or converted to be used as the power source 50. However, if the operating power supplied via the communication antenna 10 is not sufficient, the voltage of the connection command signal might be lowered. If the voltage of the connection command signal is lowered, the switch 30 is turned into the OFF-state so that the communication section 20 is protected from the overvoltage but cannot communicate with the external device (not shown). In contrast, if the power source 50 is a battery, the communicating state can be maintained even under a case where the electric power is not received from the external device. Accordingly, in a view point of stably maintaining the communicating state, the power source 50 is preferred to be a battery.

The battery used as the power source 50 may be any one of a primary battery and a secondary battery. However, when the communication device 1 has a non-contact charging function (not shown) using an electric power reception antenna, a rectifier circuit, a smoothing circuit, a charging control circuit, etc., the power source 50 is desirable to be a secondary battery which is charged by the non-contact charging function. In this structure, the power source 50 more reliably supplies the operating power to the switch control section 40 and the booster circuit 42. Accordingly, the communicating state can be more securely maintained.

As previously described, the power source 50 supplies the operating power also to the switch control section 40. If the supply of the operating power from the power source 50 is stopped for some reason, the switch control section 40 does not output the connection command signal. As a result, the switch 30 is turned into the OFF-state so that the communication section 20 is protected from the overvoltage. According to the present embodiment, the communication section 20 can be protected even if the power source 50 is broken down.

The CPU 60 according to the present embodiment is connected to the communication section 20 and the switch control section 40. The CPU 60 sends a signal, namely, an indication signal, to the switch control section 40 when the communication section 20 transmits the signal, wherein the indication signal indicates that the communication section 20 is in the signal transmitting state. Accordingly, the switch control section 40 is capable of detecting whether the communication section 20 is in the signal transmitting state or not depending on whether the indication signal is sent or not. As described later, the switch control section 40 according to the present embodiment works differently depending on whether the indication signal is sent or not. As can be seen from the above explanation, if the communication section 20 does not transmit the signal but only performs load modulation communication or only receives the signal, the function related to the indication signal is unnecessary.

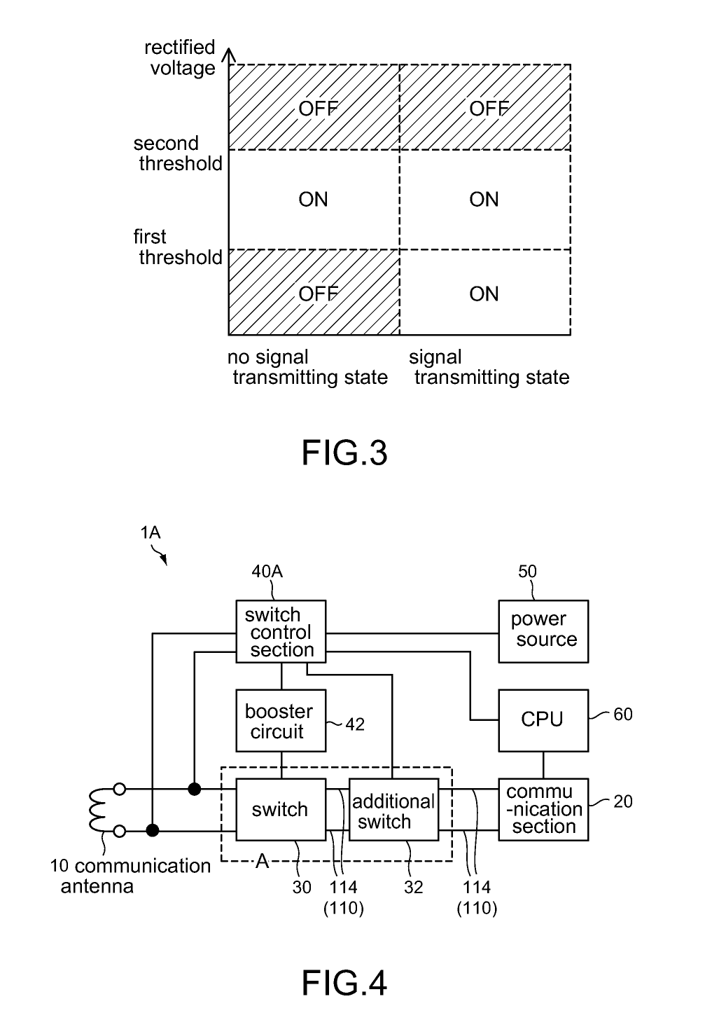

Hereafter, further detailed explanation is made about functions of the switch 30 and the switch control section 40 according to the present embodiment as referring to FIGS. 1 and 3.

In the present embodiment, a first threshold is a lower limit (or a value about the lower limit) of a signal voltage necessary to communicate via the communication antenna 10, and a second threshold is an upper limit (or a value about the upper limit) of a signal voltage which does not apply the overvoltage to the communication section 20. More specifically, the first threshold a lower limit of the detected voltage which is detected by the switch control section 40 when the communication section 20 receives the signal. The second threshold is the predetermined value which is larger than an upper limit of a voltage that is to be generated because of the transmission of the signal by the communication section 20 via the communication antenna 10, and which is smaller than the overvoltage. The second threshold is larger than the first threshold.

As previously described, the switch control section 40 obtains the voltage generated in the communication antenna 10 via the rectifier circuit (not shown) as the rectified voltage (detected voltage). In addition, the switch control section 40 obtains the indication signal from the CPU 60, wherein the indication signal indicates that the communication section 20 is in the signal transmitting state. The switch control section 40 controls the switch 30 by using the detected voltage and the indication signal.

Specifically, the switch control section 40 controls the switch 30 as described below under a condition where the communication section 20 is not in the signal transmitting state, or under a case where the indication signal is not received from the CPU 60.

The switch control section 40 does not output the connection command signal to the booster circuit 42 under a condition where the detected voltage is not larger than the first threshold, for example, under a case where the communication antenna 10 does not receive the signal. As a result, the switch 30 is in the OFF-state. In the meantime, the consumption of the operating power in the booster circuit 42 is suppressed. The power source 50 may be formed so as not to supply the operating power to the switch control section 40 under the condition where the detected voltage is not larger than the first threshold. For example, the power source 50 may receive the detected voltage to determine whether the operating power needs to be supplied or not.

The switch control section 40 outputs the connection command signal to the switch 30 via the booster circuit 42 under a condition where the detected voltage is larger than the first threshold and is not larger than the second threshold, for example, under a case where the communication antenna 10 receives the signal. As a result, the switch 30 is turned into the ON-state to enable the communication section 20 to communicate.

The switch control section 40 does not output the connection command signal to the booster circuit 42 under a condition where the detected voltage is larger than the second threshold, for example, under a case where the communication antenna 10 receives the electric power. As a result, the switch 30 is turned into OFF-state to protect the communication section 20.

The switch control section 40 controls the switch 30 as described below under a condition where the communication section 20 is in the signal transmitting state, or under a case where the indication signal is received from the CPU 60.

The switch control section 40 outputs the connection command signal to the switch 30 via the booster circuit 42 under a condition where the detected voltage is not larger than the second threshold. As a result, the switch 30 is turned into the ON-state to enable the communication section 20 to communicate. When the communication section 20 is transferred into the signal transmitting state and about to transmit the signal, the communication section 20 is electrically connected with the communication antenna 10 in advance. Moreover, under the condition where the communication section 20 is in the signal transmitting state, the communication section 20 is kept to be electrically connected with the communication antenna 10 even if the detected voltage is temporarily not larger than the first threshold. The signal transmitting state is therefore stably maintained.

The switch control section 40 does not output the connection command signal to the booster circuit 42 under the condition where the detected voltage is larger than the second threshold. As a result, the switch 30 is turned into the OFF-state to protect the communication section 20.

As can be seen from the above explanation, according to the present embodiment, under the condition where the detected voltage is not larger than the first threshold, the switch control section 40 controls the switch 30 depending on whether the communication section 20 is in the signal transmitting state or not. In detail, the switch control section 40 stops the connection command signal under the condition where the communication section 20 is not in the signal transmitting state and the detected voltage is not larger than the first threshold. The switch control section 40 outputs the connection command signal under the condition where the communication section 20 is in the signal transmitting state and the detected voltage is not larger than the first threshold.

Under the condition where the detected voltage is larger than the first threshold, the switch control section 40 controls the switch 30 without depending on whether the communication section 20 is in the signal transmitting state or not. In detail, the switch control section 40 outputs the connection command signal under the condition where the detected voltage is larger than the first threshold and is not larger than the second threshold. The switch control section 40 stops the connection command signal under the condition where the detected voltage is larger than the second threshold.

According to the present embodiment, when the communication device 1 receives the electric power in a non-contact manner, the switch 30 breaks the signal lines 110 to prevent the communication section 20 from the overvoltage. In addition, even if the communication device 1 does not have the non-contact electric power transmission function, the communication section 20 is prevented from the overvoltage under a case where the communication device 1 is placed in the vicinity of a device transmitting the electric power. Moreover, when the signal lines 110 are broken, impedance between the opposite ends of the communication antenna 10 becomes higher. Accordingly, when the communication device 1 receives the electric power in a non-contact manner, loss of the transmitted electric power is prevented.

Moreover, according to the present embodiment, by making the voltage of the connection command signal sufficiently higher than the voltage of the signal lines 110, the communication section 20 can be electrically stably connected with the communication antenna 10 and can be electrically reliably disconnected from the communication antenna 10.

Moreover, according to the present embodiment, the signal lines 110 are broken when the connection command signal is not output. Accordingly, when the signal lines 110 are broken, electric power loss due to the switch control section 40 and the booster circuit 42 is reduced.

The communication device 1 according to the present embodiment can be variously modified in addition to the already described modifications.

For example, when the communication section 20 does not transmit the signal but only performs the load modulation communication or only receives the signal, the switch control section 40 may stop the connection command signal also under the condition where the detected voltage is not larger than the first threshold without depending on whether the communication section 20 is in the signal transmitting state or not.

Moreover, the switch control section 40 may be formed to receive a DC voltage while the switch control section 40 is provided with no rectifier circuit (not shown). For example, when an impedance matching circuit (not shown) is provided between the communication antenna 10 and the switch 30, the switch control section 40 may be connected to the signal lines 112 between the impedance matching circuit and the switch 30. By this structure, the switch control section 40 can directly detect the voltage applied to the communication section 20.

Moreover, the switch control section 40 may obtain the detected voltage without using the rectifier circuit (not shown). For example, the switch control section 40 may obtain the detected voltage by performing envelope detection of the signal on the signal lines 110.

### Second Embodiment

As can be seen from FIGS. 1 and 4, a communication device 1A according to a second embodiment of the present invention is a modification of the communication device 1 according to the first embodiment. Specifically, the communication device 1A comprises an additional switch 32. Moreover, the communication device 1A comprises, instead of the switch control section 40, a switch control section 40A slightly different from the switch control section 40. In detail, the switch control section 40A is connected not only to the booster circuit 42 but also to the additional switch 32. The communication device 1A has structure and function similar to those of the communication device 1 except for the aforementioned difference. Hereafter, explanation is mainly made about this difference.

As shown in FIG. 4, the additional switch 32 is connected between the switch 30 and the communication section 20. The additional switch 32 is also connected to the switch control section 40A without the booster circuit 42. The additional switch 32 is controlled by the connection command signal received from the switch control section 40A similar to the switch 30.

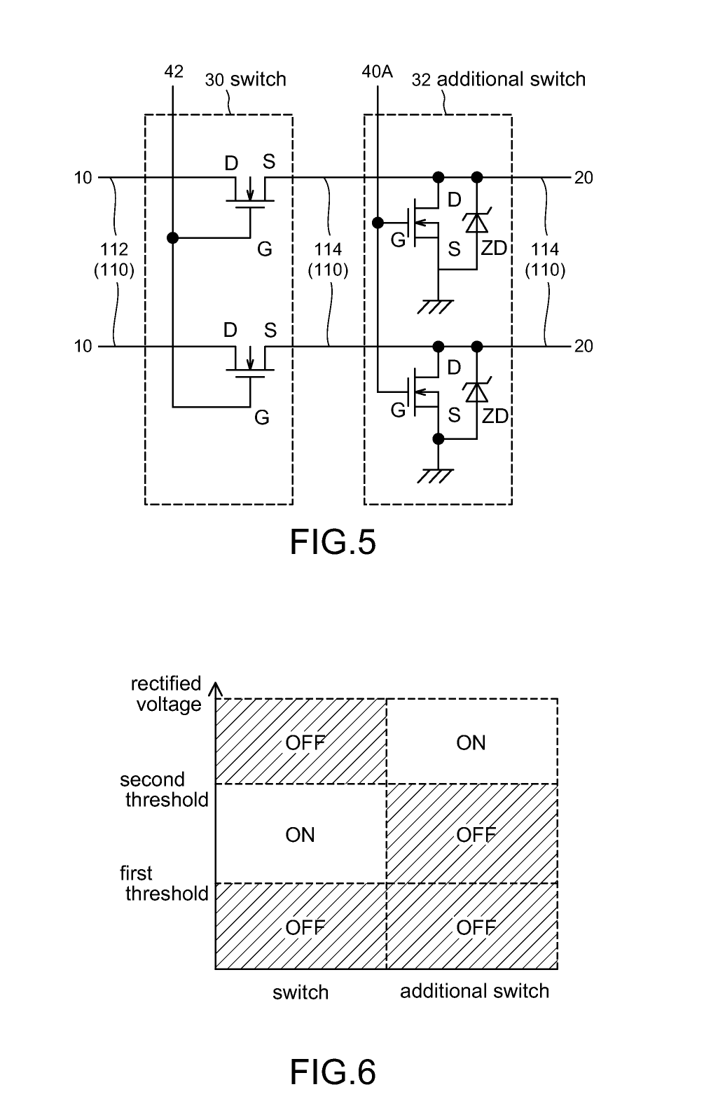

As shown in FIG. 5, the switch 30 according to the present embodiment is formed of two n-type MOSFETs like the first embodiment (see FIG. 2).

The additional switch 32 is formed of semiconductor switches similar to the switch 30. However, the additional switch 32 is formed differently from the switch 30 by using two n-type MOSFETs. For each MOSFET, the drain is connected to the signal line 114, and the source is grounded. For each MOSFET, the gate is connected not to the booster circuit 42 but to the switch control section 40A.

Since the source of the additional switch 32 is connected to the ground, the additional switch 32 is turned into an ON-state by the connection command signal on the basis of the ground potential. Accordingly, the connection command signal of the switch control section 40A is directly output to the gate without passing through the booster circuit 42. When the connection command signal is output to the gate, the additional switch 32 is in the ON-state. In the meantime, the signal lines 114 are connected to the ground so that the communication section 20 is electrically disconnected from the switch 30. On the other hand, when no connection command signal is applied to the gate, the additional switch 32 is in an OFF-state. In the meantime, the signal lines 114 are not grounded so that the communication section 20 is electrically connected with the switch 30.

As can be seen from the above explanation, the connection command signal applied to the additional switch 32 by the switch control section 40A works as a disconnection command signal.

Even when the switch 30 is in the OFF-state, the signal lines 114 cannot be electrically completely isolated from the signal lines 112. In other words, complete electrical disconnection between the communication antenna 10 and the communication section 20 cannot be achieved. However, the additional switch 32 according to the present embodiment electrically disconnects the communication section 20 from the switch 30 when receiving the connection command signal (disconnection command signal). The additional switch 32 can be turned into the ON-state at the same time as the switch 30 is turned into the OFF-state. The communication section 20 can be therefore more securely protected. In addition, the additional switch 32 according to the present embodiment has a protection function using zener diodes (ZD). Accordingly, the communication section 20 can be almost completely protected.

The additional switch 32 electrically connects the communication section 20 with the switch 30 when not receiving the connection command signal (disconnection command signal). The additional switch 32 can be turned into the OFF-state at the same time as the switch 30 is turned into the ON-state. The communication by the communication section 20 can be therefore stably maintained.

Hereafter, explanation is made about functions of the additional switch 32 and the switch control section 40A according to the present embodiment as referring to FIGS. 4, 6 and 7. The function of the switch 30 is same as the function thereof in the first embodiment (see FIG. 3) and is therefore not explained.

The switch control section 40A controls the additional switch 32 as described below not depending on whether the communication section 20 is in the signal transmitting state or not.

Specifically, the switch control section 40A outputs the disconnection command signal (connection command signal) to the additional switch 32 under the condition where the detected voltage is larger than the second threshold. As a result, the switch 30 is turned into the ON-state. The communication section 20 is electrically disconnected from the switch 30. The switch control section 40A stops the disconnection command signal (connection command signal) directed to the additional switch 32 under the condition where the detected voltage is not larger than the second threshold. As a result, the additional switch 32 is turned into the OFF-state. The communication section 20 is electrically connected with the switch 30.

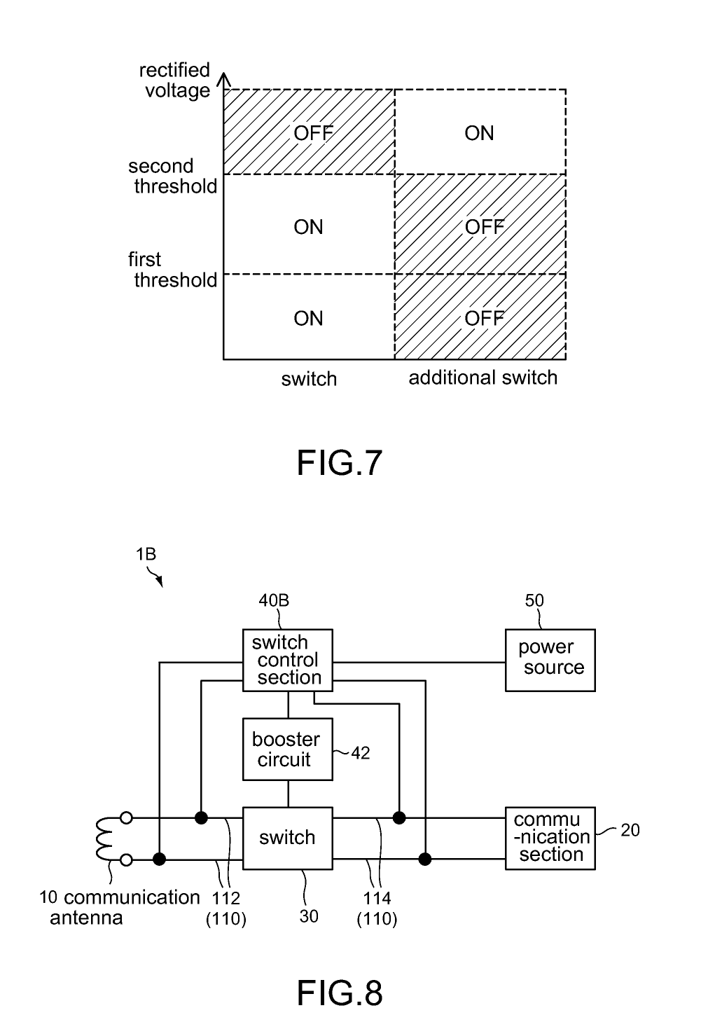

As can be seen from FIGS. 6 and 7, when the switch 30 and the additional switch 32 are provided, the overvoltage to the communication section 20 is more securely blocked and the communication section 20 is more securely protected in particular under the condition where the detected voltage is larger than the second threshold. Moreover, under the condition where the detected voltage is not larger than the first threshold, the connection command signal does not need to be output to the additional switch 32 because the additional switch 32 can be available even in the OFF-state. Accordingly, consumption of the electric power can be suppressed.

### Third Embodiment

As can be seen from FIGS. 1 and 8, a communication device 1B according to a third embodiment of the present invention is a modification of the communication device 1 according to the first embodiment. Specifically, the communication device 1B comprises, instead of the switch control section 40, a switch control section 40B slightly different from the switch control section 40. In detail, the switch control section 40B is not connected to the CPU 60 (not illustrated in FIG. 8) but is connected to the signal lines 114. The communication device 1B has structure and function similar to those of the communication device 1 except for the aforementioned difference. Hereafter, explanation is mainly made about this difference.

As can be seen from FIG. 8, the switch control section 40B can directly detect the voltage of the transmission signal of the communication section 20 from the signal lines 114. In detail, the switch control section 40B according to the present embodiment smoothes the voltage of the signal lines 114 to obtain a smoothed voltage. As explained below, the switch control section 40B determines whether the communication section 20 is in the signal transmitting state or not by using this smoothed voltage.

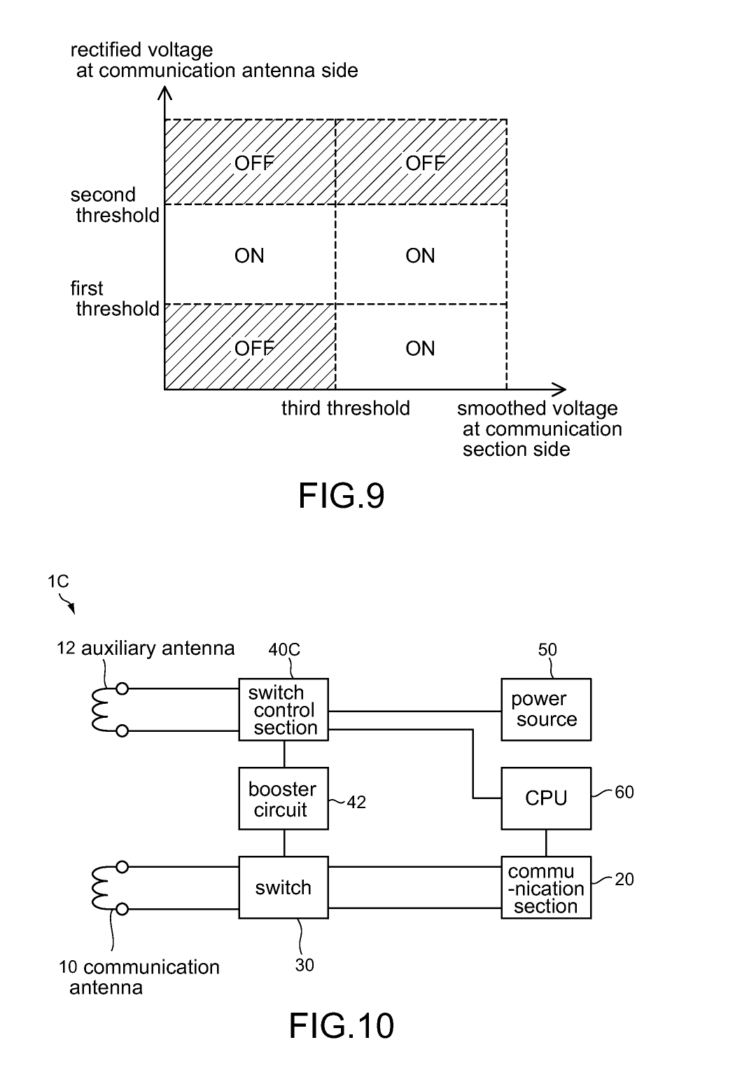

As shown in FIG. 9, the switch control section 40B controls the switch 30 similar to the first embodiment (see FIG. 3) and the second embodiment (see FIGS. 6 and 7) under the condition where the detected voltage is larger than the first threshold. However, the switch control section 40B controls the switch 30 by using the aforementioned smoothed voltage under the condition where the detected voltage is not larger than the first threshold. In detail, the switch control section 40B turns the switch 30 into the OFF-state under a condition where the smoothed voltage is not larger than a predetermined third threshold. The switch control section 40B turns the switch 30 into the ON-state under a condition where the smoothed voltage is larger than the predetermined third threshold.

Under the condition where the communication section 20 in not in the signal transmitting state and the detected voltage is not larger than the first threshold, the switch 30 is in the OFF-state. Accordingly, when the communication section 20 starts to transmit the signal, the switch 30 needs to be turned into the ON-state. Since the switch control section 40B according to the present embodiment works as described above, the switch 30 is turned into the ON-state under a case where the smoothed voltage becomes larger than the third threshold because of the transition of the communication section 20 into the signal transmitting state. As a result, the communication section 20 can transmit the signal.

As can be seen from the above explanation, the switch control section 40B according to the present embodiment is capable of detecting whether the communication section 20 is in the signal transmitting state or not by using not the indication signal of the CPU 60 (see FIG. 1) but the smoothed voltage.

### Fourth Embodiment

As can be seen from FIGS. 1 and 10, a communication device 1C according to a fourth embodiment of the present invention is a modification of the communication device 1 according to the first embodiment. Specifically, the communication device 1C comprises an auxiliary antenna 12 in addition to the communication antenna 10. Moreover, the communication device 1C comprises, instead of the switch control section 40, a switch control section 40C slightly different from the switch control section 40. In detail, the switch control section 40C is not connected to the communication antenna 10 but is connected to the auxiliary antenna 12. The communication device 1C has structure and function similar to those of the communication device 1 except for the aforementioned difference. Hereafter, explanation is mainly made about this difference.

The auxiliary antenna 12 may be any antenna, provided that the antenna is other than the communication antenna 10 and is magnetically coupled with the communication antenna 10 during the signal transmission/reception. For example, when the communication device 10 comprises an electric-power-receiving loop antenna which receives the electric power in a non-contact manner, this electric-power-receiving loop antenna may be used as the auxiliary antenna 12.

The switch control section 40C does not directly detect the voltage of the communication antenna 10 as the detected voltage but detects, as the detected voltage, a voltage that is generated in the auxiliary antenna 12 because of the signal transmission/reception with use of the communication antenna 10. In other words, in the present embodiment, the detected voltage is the voltage that is generated in the auxiliary antenna 12 because of the signal transmission/reception with use of the communication antenna 10. The thus-formed switch control section 40C can control the switch 30 similar to the switch control section 40 (see FIGS. 1 and 3).

Moreover, when the communication antenna 10 and the auxiliary antenna 12 are arranged so as to weaken the magnetic coupling therebetween, the detected voltage can be properly detected from the auxiliary antenna 12 with almost no affection to the voltage in the communication antenna 10.

### Fifth Embodiment

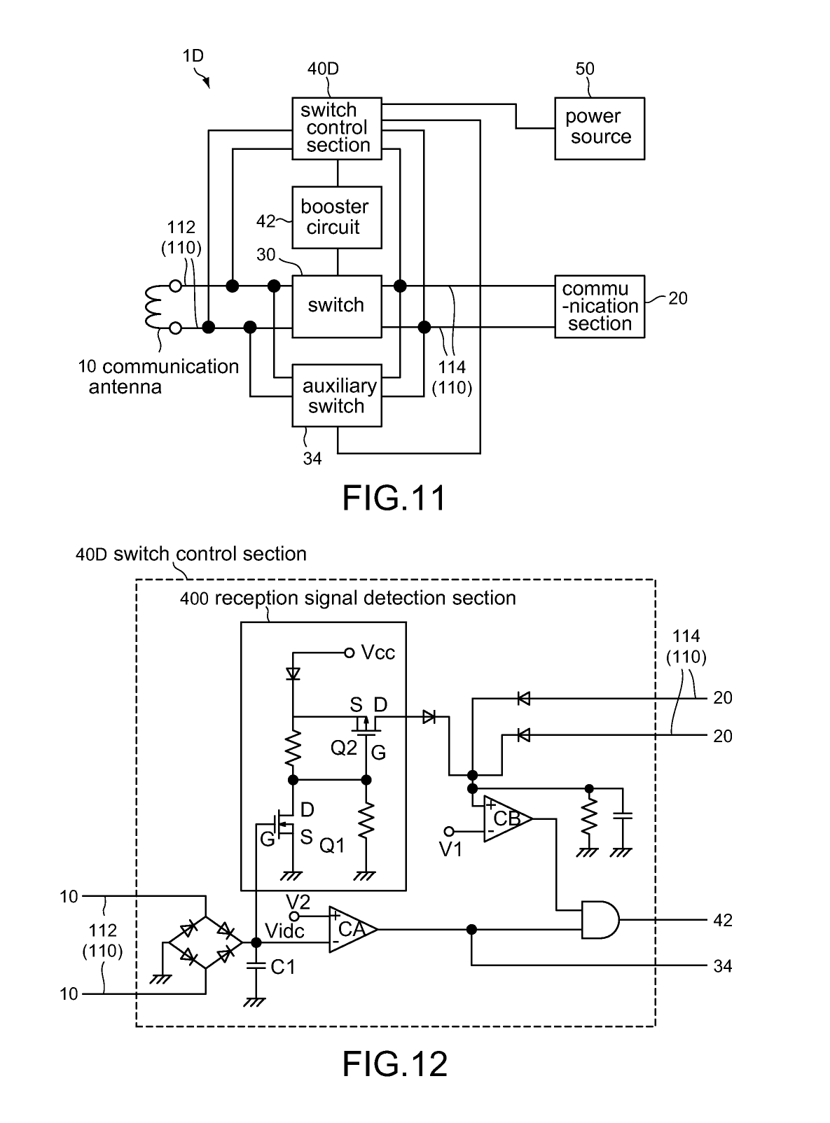

As can be seen from FIGS. 8 and 11, a communication device 1D according to a fifth embodiment of the present invention is a modification of the communication device 1B according to the third embodiment. Specifically, the communication device 1D comprises an auxiliary switch 34 in addition to the switch 30. Moreover, the communication device 1D comprises, instead of the switch control section 40B, a switch control section 40D slightly different from the switch control section 40B. In detail, the switch control section 40D is connected not only to the booster circuit 42 but also to the auxiliary switch 34. The communication device 1D has structure and function similar to those of the communication device 1B except for the aforementioned difference. Hereafter, explanation is mainly made about this difference.

As shown in FIG. 11, the auxiliary switch 34 is connected between the communication antenna 10 and the communication section 20 in parallel to the switch 30. In other words, the auxiliary switch 34 is provided on the signal lines 110 similar to the switch 30. The auxiliary switch 34 is connected to the switch control section 40D without the booster circuit 42. The auxiliary switch 34 can be formed of semiconductor switches similar to the switch 30 (see FIG. 2). For example, the auxiliary switch 34 may be formed of two n-type MOSFETs similar to the switch 30.

As can be seen from FIG. 11, the switch control section 40D outputs the connection command signal to the switch 30 and the auxiliary switch 34. The connection command signal directed to the auxiliary switch 34 is output, for example, to the gate of the MOSFET.

Specifically, as shown in FIG. 12, the switch control section 40D according to the present embodiment is formed of a circuit using semiconductors. Hereafter, in reference with FIG. 12, explanation is made about a function of the switch control section 40D under a case where a predetermined voltage is generated in the signal lines 112, for example, under a case where the communication device 1D receives the signal.

The switch control section 40D full-wave rectifies the voltage of the signal lines 112 by using a diode bridge. The switch control section 40D smoothes the full-wave rectified voltage by using a smoothing circuit formed of a capacitor C1 so that the full-wave rectified voltage is converted into a rectified voltage Vidc (detected voltage). The rectified voltage Vidc is input to an inverted input of a comparator CA. In addition, a voltage V2 of the second threshold is input to a non-inverted input of the comparator CA. The output of the comparator CA is output to each of the auxiliary switch 34 and an AND circuit as the connection command signal.

The switch control section 40D includes a reception signal detection section 400. In other words, the communication device 1D comprises the reception signal detection section 400. The rectified voltage Vidc (detected voltage) is also input to the reception signal detection section 400. In detail, the rectified voltage Vidc is input to the gate of an n-type MOSFET (Q1). The source of the MOSFET (Q1) is grounded. Accordingly, electric potential difference between the gate and the source becomes larger because of the input rectified voltage Vidc so that the drain and the source are electrically connected with each other. As a result, a drain voltage of the MOSFET (Q1) is lowered. Since a gate voltage of a p-type MOSFET (Q2) connected to the drain of the MOSFET (Q1) is also lowered, the drain and the source of the MOSFET (Q2) are electrically connected with each.

Since the reception signal detection section 400 works as described above, a power supply voltage Vcc is input to a non-inverted input of a comparator CB via the MOSFET (Q2) and a diode under a case where the predetermined voltage is generated in the signal lines 112. The voltage of the signal lines 114 is also smoothed by a diode and a capacitor and boosted as necessary (not shown) to be input to the non-inverted input of the comparator CB as a smoothed voltage at the communication section 20 side. In addition, a voltage V1 of a predetermined value is input to an inverted input of the comparator CB. The output of the comparator CB is input to the AND circuit. The output of the AND circuit is output to the booster circuit 42.

In the switch control section 40D shown in FIG. 12 as an example, the first threshold of the rectified voltage Vidc (detected voltage) is equal to the gate voltage necessary to electrically connect the drain and the source of the MOSFET (Q1) with each other. When the drain and the source of the MOSFET (Q1) are electrically connected with each other, a power supply voltage Vcc, which is larger than the voltage V1 of the predetermined value, is input to the comparator CB. Accordingly, even if the rectified voltage Vidc is so weak as the comparator CB cannot directly detect it, the comparator CB can detect the rectified voltage Vidc by using the power supply voltage Vcc. For example, even when the communication antenna 10 receives a weak signal, the switch 30 can be controlled so that the signal lines 112 are electrically connected with the signal lines 114, respectively.

The switch control section 40D may be formed so that a level of the voltage (predetermined voltage), or the power supply voltage Vcc in FIG. 12, input to the comparator CB changes depending on another level of the rectified voltage Vidc (detected voltage). According to this structure, the rectified voltage Vidc (detected voltage) is converted into the predetermined voltage by the reception signal detection section 400 to be input to the comparator CB. In this structure, the comparator CB can indirectly compare the rectified voltage Vidc with the first threshold when the voltage V1 is set to a value corresponding to the first threshold. In other words, the switch control section 40D compares the rectified voltage Vidc and the first threshold with each other by using the rectified voltage Vidc which is amplified by the reception signal detection section 400. Accordingly, even if the rectified voltage Vidc is as weak as the comparator CB cannot directly detect, the comparator CB can detect the rectified voltage Vidc by using the predetermined voltage. A small first threshold can be therefore set for the rectified voltage Vidc. For example, even when the communication antenna 10 receives a weak signal, the switch 30 can be controlled to electrically connect the signal lines 112 to the signal lines 114, respectively.

As described above, the rectified voltage Vidc (detected voltage) detected by the switch control section 40D is input to the gate of the MOSFET (Q1). When the switch control section 40D is thus formed of the circuit using the semiconductors, the lower detectable limit of the rectified voltage Vidc is often restricted to a barrier voltage about 0.6V in a p-n junction of a semiconductor. Accordingly, the first threshold needs to be set larger than the barrier voltage. However, for example, when the communication section 20 is formed of an IC chip which is in compliant with the ISO/IEC 18092 standard, the communication section 20 often uses some reception signal having a voltage smaller than 0.6 V in order to determine whether the signal transmission is allowed or not. The voltage of the reception signal is therefore sometimes smaller than the first threshold. In order to allow the communication section 20 to receive such weak reception signal, the communication section 20 and the communication antenna 10 need to be electrically connected with each other even when the switch 30 is in the OFF-state.

According to the present embodiment, the connection command signal is output to the auxiliary switch 34, provided that the rectified voltage Vidc (detected voltage) is not larger than the second threshold. Accordingly, the auxiliary switch 34 continues to electrically connect the communication section 20 with the communication antenna 10 even if the rectified voltage Vidc is smaller than the barrier voltage. Since the auxiliary switch 34 is thus provided, the communication section 20 can receive the weak reception signal for determining whether the transmission of the signal is allowed or not even under a case where the switch 30 is in the OFF-state.

Moreover, no circuit such as the booster circuit 42 which consumes large electric power is not provided between the auxiliary switch 34 and the switch control section 40D. Accordingly, the auxiliary switch 34 consumes only slight electric power for continuing to electrically connect the communication section 20 with the communication antenna 10. Moreover, when the power source 50 does not supply the electric power to the switch control section 40D, the auxiliary switch 34 does not work. In other words, the auxiliary switch 34 is in the OFF-state. Accordingly, even if the electric power from the power source 50 is stopped, the communication section 20 is protected from the overvoltage.

Hereafter, explanation is made about functions of the switch 30, the auxiliary switch 34 and the switch control section 40D according to the present embodiment as referring to FIGS. 11 and 13 to 16.

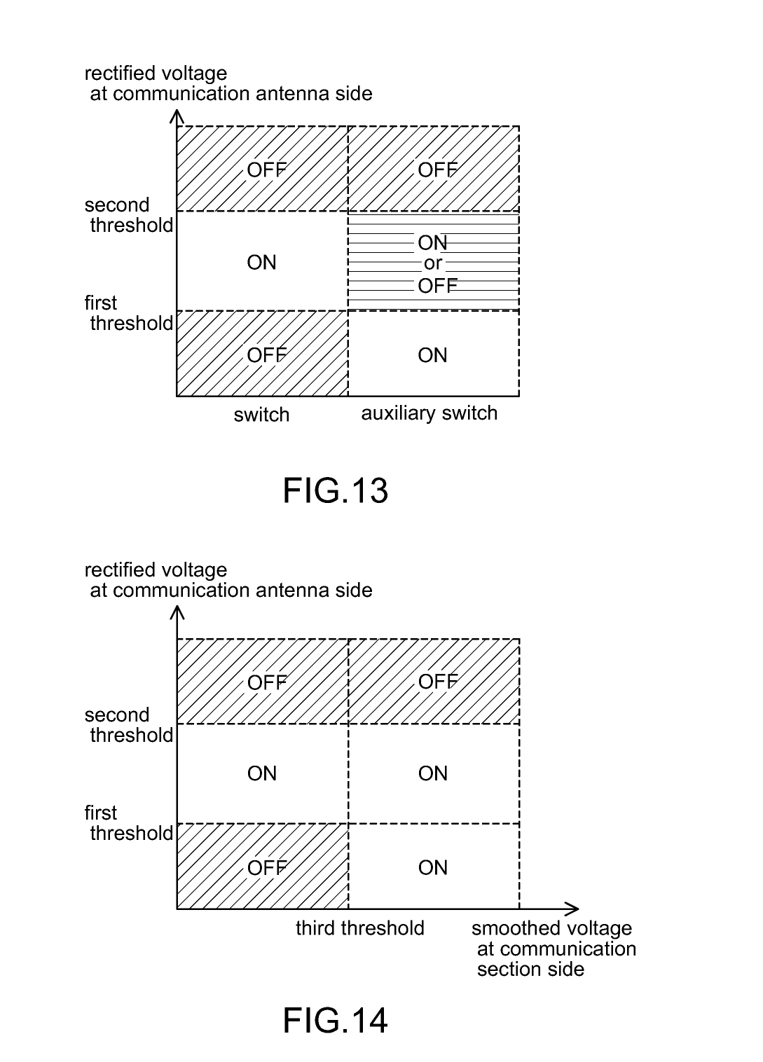

Referring to FIGS. 11 and 13, when the communication section 20 is in a signal receiving state, the auxiliary switch 34 is in an ON-state even under a condition where the rectified voltage Vidc (detected voltage) is not larger than the first threshold. Accordingly, the communication section 20 can determine whether a weak reception signal exists or not, wherein the weak reception signal is used for determination of whether the signal transmission is allowed or not.

Referring to FIGS. 11 and 14, the switch 30 according to the present embodiment works similar to the switch 30 according to the third embodiment (see FIG. 9). However, when the switch control section 40D is formed as shown in FIG. 12, the first threshold is equal to the third threshold.

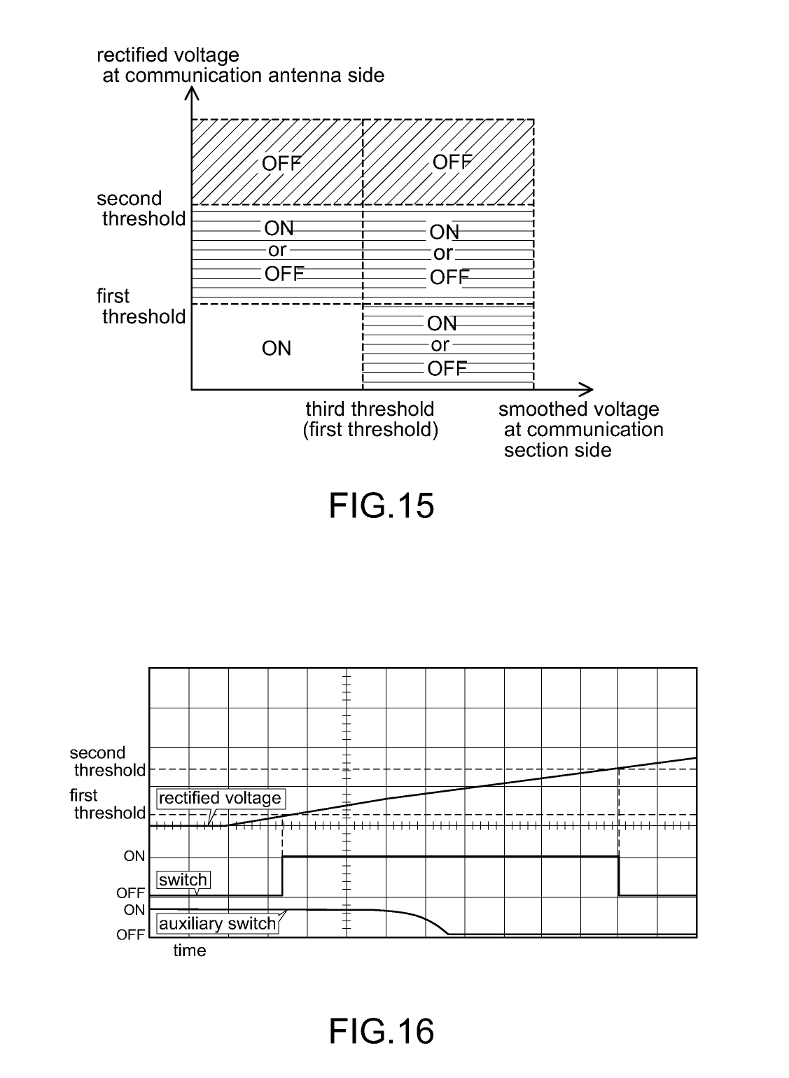

As can be seen from FIG. 12, the auxiliary switch 34 works with no direct relation with the smoothed voltage at the communication section 20 side according to the present embodiment. In other words, the auxiliary switch 34 basically works only depending on the rectified voltage Vidc (detected voltage). However, as can be seen from FIG. 11, the rectified voltage Vidc and the smoothed voltage are related to each other. Accordingly, the function of the auxiliary switch 34 has indirect relation with the smoothed voltage. More specifically, referring to FIGS. 11 and 15, the auxiliary switch 34 works as described below.

The switch control section 40D outputs the connection command signal to the auxiliary switch 34 under a condition where the rectified voltage Vidc (detected voltage) due to the communication antenna 10 is not larger than the second threshold. The auxiliary switch 34 is basically in the ON-state when receiving the connection command signal. In detail, the auxiliary switch 34 is in the ON-state under a condition where the rectified voltage Vidc is not larger than the first threshold. In addition, the auxiliary switch 34 is basically in the ON-state under a condition where the rectified voltage Vidc is larger than the first threshold and is not larger than the second threshold.

However, under the condition where the rectified voltage Vidc (detected voltage) is larger than the first threshold and is not larger than the second threshold, electric potential between the voltage of the connection command signal output to the auxiliary switch 34 and the voltage of the signal lines 110 sometimes becomes small. At that time, the auxiliary switch 34 cannot keep the ON-state and is turned into an OFF-state. For example, in some cases, the voltage of the signal lines 110 increases because of the signal transmission by the communication section 20 so that the auxiliary switch 34 is turned into the OFF-state. As a result, the auxiliary switch 34 electrically disconnects the communication section 20 from the communication antenna 10. When the auxiliary switch 34 according to the present embodiment receives the connection command signal, the auxiliary switch 34 electrically connects the communication section 20 with the communication antenna 10 at least under the condition where the rectified voltage Vidc is not larger than the first threshold.

As described above, under the condition where the rectified voltage Vidc (detected voltage) of the switch control section 40D is larger than the first threshold and is not larger than the second threshold, the switch 30 electrically connects the communication section 20 with the communication antenna 10. Accordingly, the communication section 20 continues to be electrically connected with the communication antenna 10 regardless of whether the auxiliary switch 34 is in the ON-state or in the OFF-state. In other words, according to the present embodiment, the auxiliary switch 34 may be in any one of the ON-state and the OFF-states under the condition where the rectified voltage Vidc is larger than the first threshold and is not larger than the second threshold.

The switch control section 40D stops the connection command signal directed to the auxiliary switch 34 under a condition where the rectified voltage Vidc (detected voltage) is larger than the second threshold. The auxiliary switch 34 electrically disconnects the communication section 20 from the communication antenna 10 when not receiving the connection command signal. As a result, both the switch 30 and the auxiliary switch 34 are turned into the OFF-state, and the communication section 20 is therefore protected.

As shown in FIG. 16, for example, when the rectified voltage Vidc (detected voltage) is uniformly increased over time, the state of each of the switch 30 and the auxiliary switch 34 is transferred as described below.

Before the rectified voltage Vidc (detected voltage) exceeds the first threshold, the switch 30 is in the OFF-state but the auxiliary switch 34 is kept to be in the ON-state. Accordingly, the communication section 20 is electrically connected with the communication antenna 10.

After the rectified voltage Vidc (detected voltage) exceeds the first threshold, the electric potential difference between the gate and the source of the auxiliary switch 34 (MOSFET) gradually decreases. Accordingly, the auxiliary switch 34 cannot keep the ON-state and is turned into the OFF-state. However, the switch 30 keeps the ON-state because of the booster circuit 42. Accordingly, the communication section 20 continues to be electrically connected with the communication antenna 10 with no affection of the action of the auxiliary switch 34.

When the rectified voltage Vidc (detected voltage) exceeds the second threshold, both the switch 30 and the auxiliary switch 34 are in the OFF-state. Accordingly, the communication section 20 is electrically disconnected from the communication antenna 10, and the communication section 20 is therefore protected.

The communication device 1D according to the present embodiment can be variously modified in addition to the already described modifications. For example, the reception signal detection section 400 of the switch control section 40D may be replaced by any amplifying circuit which can amplify a weak voltage, an operational amplifier, a comparator or the like.

Moreover, as can be seen from the above explanation, each of the aforementioned switch control sections according to the first to fourth embodiments can be formed similar to the switch control section 40D according to the present embodiment. For example, the switch control section 40B (see FIG. 8) according to the third embodiment can be formed by omitting lines directed to the auxiliary switch 34 from the switch control section 40D.

### Sixth Embodiment

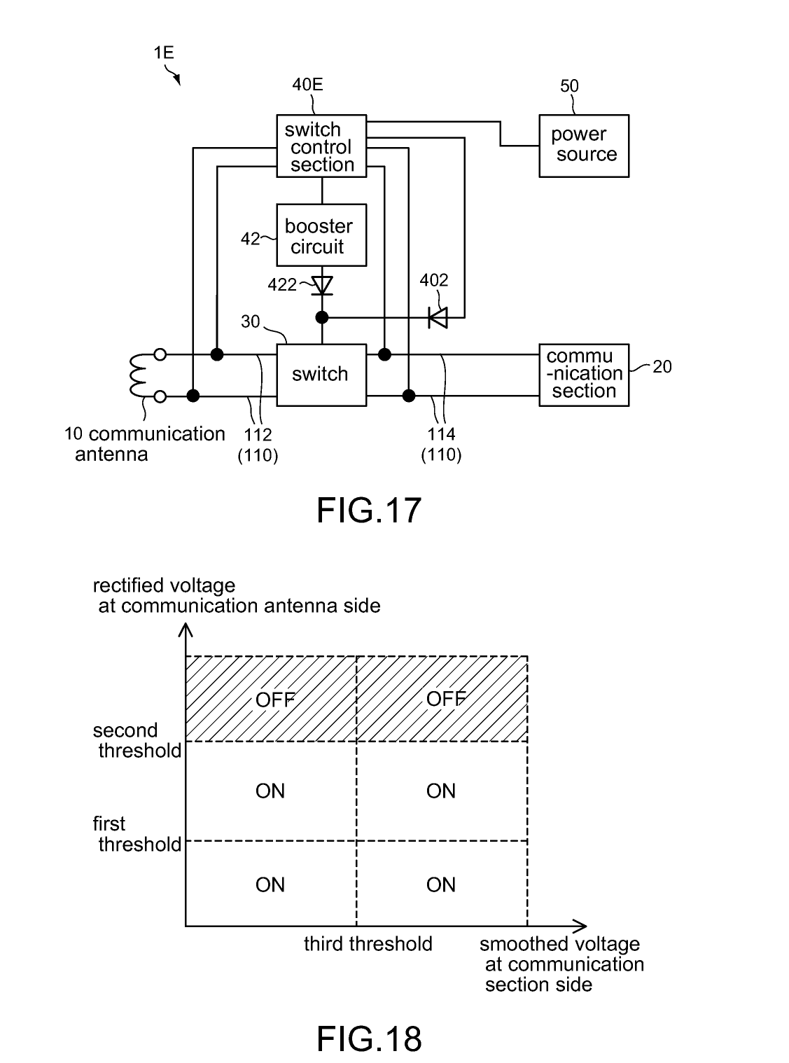

As can be seen from FIGS. 11 and 17, a communication device 1E according to a sixth embodiment of the present invention is a modification of the communication device 1D according to the fifth embodiment. Specifically, the communication device 1E does not comprise the auxiliary switch 34. Moreover, the communication device 1E comprises, instead of the switch control section 40D, a switch control section 40E slightly different from the switch control section 40D. The communication device 1E has structure and function similar to those of the communication device 1D except for the aforementioned difference. Hereafter, explanation is mainly made about this difference.

As shown in FIG. 17, the switch control section 40E is connected to the switch 30 without the booster circuit 42 via a first diode (diode) 402 in addition to connection via the booster circuit 42. The booster circuit 42 is connected to the switch 30 via a second diode (diode) 422 other than the first diode 402. The switch control section 40E outputs the connection command signal to the diode 422 via the booster circuit 42 while outputting the connection command signal to the diode 402. In other words, the connection command signal is output to the switch 30 via an OR circuit formed of the diode 402 and the diode 422.

The switch control section 40E is formed similar to the switch control section 40D (see FIG. 12) according to the fifth embodiment. However, the output, or the connection command signal, of the comparator CA is output not to the auxiliary switch 34 but to the diode 402.

Referring to FIG. 14, the switch 30 according to the present embodiment is turned into the ON-state by the connection command signal via the diode 422 under a condition same as that of the switch 30 according to the fifth embodiment. Moreover, referring to FIG. 15, the switch 30 according to the present embodiment is turned into the ON-state by the connection command signal via the diode 402 under a condition same as that of the auxiliary switch 34 according to the fifth embodiment. Accordingly, the switch 30 works as shown in FIG. 18. Specifically, regardless of the level of the smoothed voltage at the communication section 20 side, the switch 30 is turned into the ON-state under the condition where the rectified voltage (detected voltage) at the communication antenna 10 side is not larger than the second threshold while being turned into the OFF-state under the condition where the detected voltage is larger than the second threshold.

In detail, the switch control section 40E outputs the connection command signal to the switch 30 via the first diode 402 and/or the second diode 422 under the condition where the detected voltage is not larger than the second threshold. Moreover, the switch control section 40E stops the connection command signal directed to the first diode 402 and the connection command signal directed to the second diode 422 under the condition where the detected voltage is larger than the second threshold. The switch 30 electrically connects the communication section 20 with the communication antenna 10 when receiving the connection command signal from one of the first diode 402 and the second diode 422. On the other hand, the switch 30 electrically disconnects the communication section 20 from the communication antenna 10 when not receiving the connection command signal from any one of the first diode 402 and the second diode 422.

Accordingly, under the condition where the detected voltage is not larger than the first threshold and the smoothed voltage at the communication section 20 side is not larger than the third threshold, or under the condition where the communication section 20 is not in the signal transmitting state, the switch 30 is turned into the ON-state by the connection command signal which does not pass through the booster circuit 42. At that time, as previously described, the switch control section 40E does not output the connection command signal to the booster circuit 42. Accordingly, electric power consumption in the booster circuit 42 is suppressed.

Under the condition where the detected voltage is larger than the first threshold or the smoothed voltage at the communication section 20 side is larger than the third threshold, or under the condition where the communication section 20 is in the signal transmitting state, the switch 30 is turned into the ON-state by the connection command signal which passes through the booster circuit 42. Accordingly, even when the voltage of the signal lines 110 increases, the electrical connection between the communication antenna 10 and the communication section 20 is stably maintained.

As can be seen from the above explanation, according to the sixth embodiment, the communication section 20 can be electrically connected with the communication antenna 10 and can be electrically disconnected from the communication antenna 10 similar to the fifth embodiment while the auxiliary switch 34 (see FIG. 11) is not provided.

### Seventh Embodiment

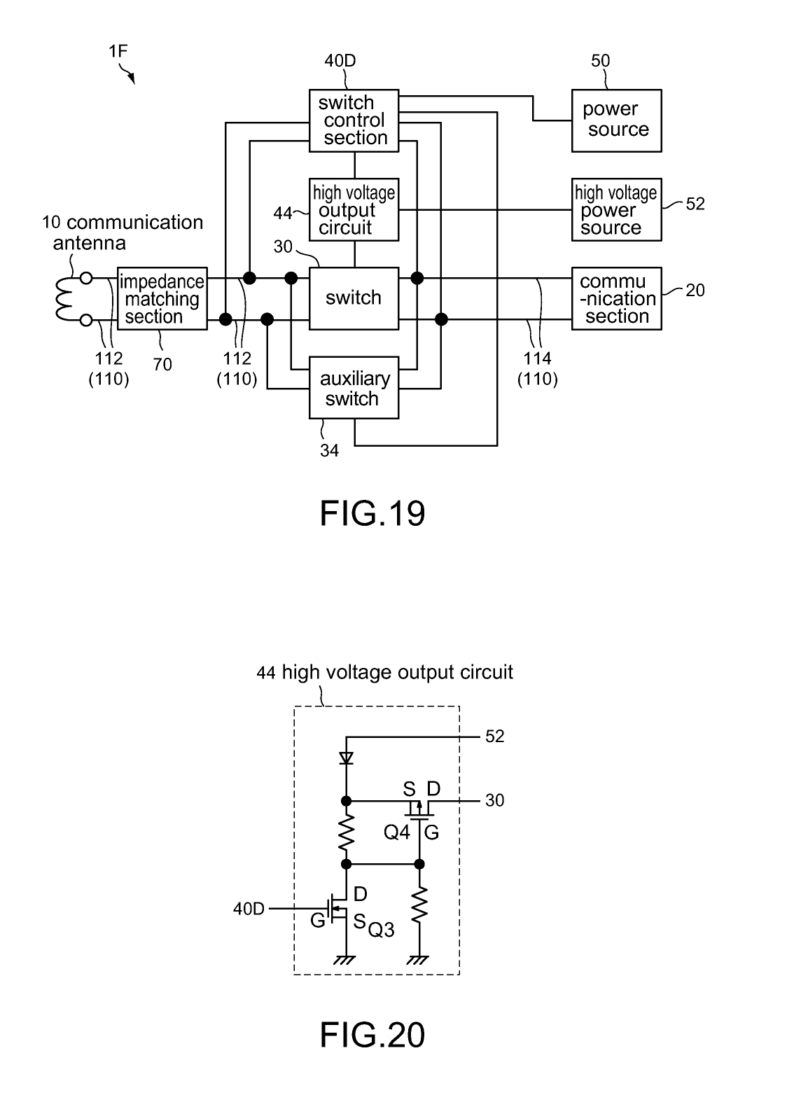

As can be seen from FIGS. 11 and 19, a communication device 1F according to a seventh embodiment of the present invention is a modification of the communication device 1D according to the fifth embodiment. Specifically, the communication device 1F comprises a high voltage output circuit (high voltage output part) 44 instead of the booster circuit 42. Moreover, the communication device 1F comprises a high voltage power source 52 and an impedance matching section 70 which are not comprised in the communication device 1D. The communication device 1F has structure and function similar to those of the communication device 1D except for the aforementioned difference. Hereafter, explanation is mainly made about this difference.

Referring to FIG. 19, the high voltage output circuit 44 according to the present embodiment works as the high voltage output part similar to the booster circuit 42 according to the first to sixth embodiments. In detail, the high voltage output circuit 44 is directly connected to the high voltage power source 52. The high voltage power source 52 supplies operating power to the high voltage output circuit 44. The high voltage output circuit 44 applies a voltage supplied from the high voltage power source 52 to the switch 30 depending on the connection command signal of the switch control section 40D.

As shown in FIG. 20, the high voltage output circuit 44 according to the present embodiment has an n-type MOSFET (Q3) and a p-type MOSFET (Q4). The source of the MOSFET (Q3) is grounded, and the drain is connected to the gate of the MOSFET (Q4). The gate of the MOSFET (Q3) is connected to the switch control section 40D. The source of the MOSFET (Q4) receives the voltage applied from the high voltage power source 52 via a diode, and the drain is connected to the switch 30.

As can be seen from FIG. 20, when the connection command signal of the switch control section 40D is input to the gate of the MOSFET (Q3), electric potential difference between the source and the gate becomes larger so that the source is electrically connected with the drain to lower a drain voltage. At that time, a gate voltage of the MOSFET (Q4) is also lowered so that the source is electrically connected with the drain. As a result, the voltage applied from the high voltage power source 52 via the diode is output to the switch 30 as the connection command signal.

According to the present embodiment, the high voltage output part is formed of the high voltage output circuit 44 which is directly connected to the high voltage power source 52. Accordingly, the function equivalent to that of the booster circuit 42 can be more reliably obtained.

Referring to FIG. 19, the impedance matching section 70 according to the present embodiment is connected between the communication antenna 10 and the switch 30. In other words, the impedance matching section 70 is proved on the signal lines 112.

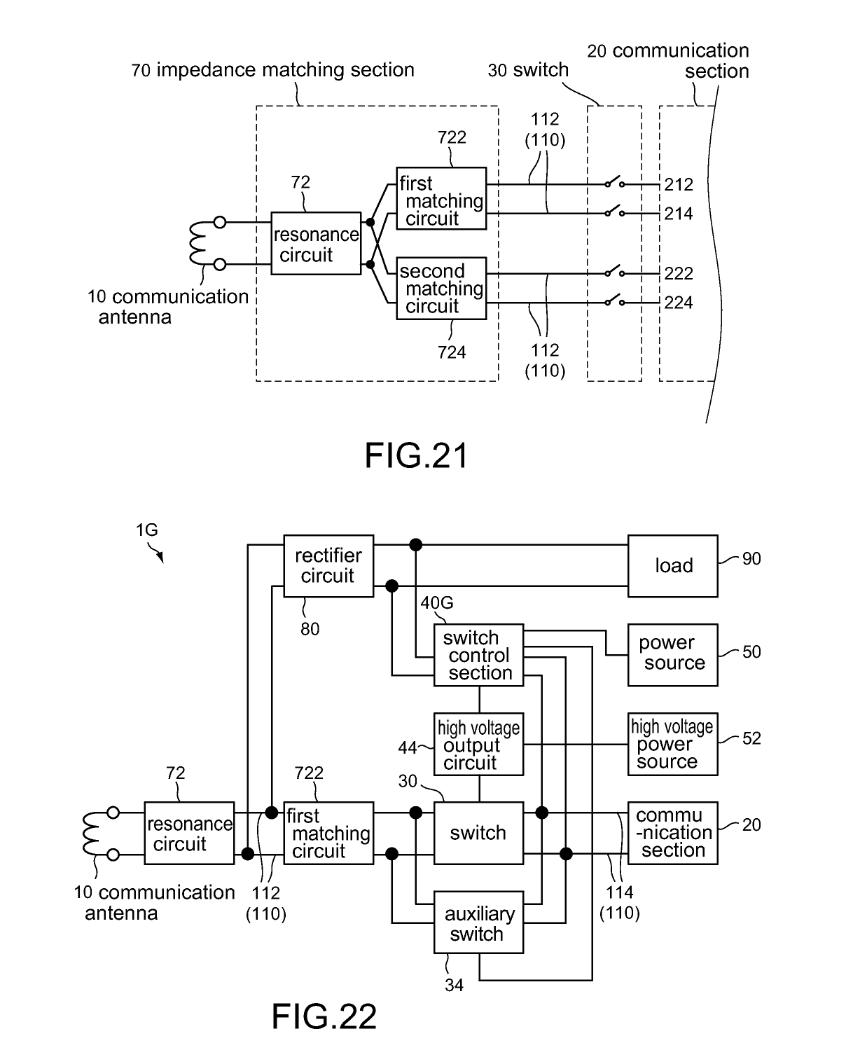

In detail, as shown in FIGS. 19 and 21, the impedance matching section 70 is connected to the communication antenna 10. In addition, the impedance matching section 70 is connected to the switch control section 40D (not illustrated in FIG. 21), the switch 30 (schematically illustrated in FIG. 21) and the auxiliary switch 34 (not illustrated in FIG. 21). The impedance matching section 70 is connected to the communication section 20 via the switch 30.

As shown in FIG. 21, the communication section 20 has two terminals (transmission/reception terminals) 212 and 214 for general communication, or for transmitting and receiving the signal, and two terminals (load modulation communication terminals) 222 and 224 for load modulation communication. The communication section 20 receives the reception signal and transmits the transmission signal from the terminals 212 and 214. Moreover, the communication section 20 performs load modulation communication by changing impedance at the terminals 222 and 224.

The impedance matching section 70 includes a resonance circuit 72, a first matching circuit (impedance matching circuit) 722 and a second matching circuit (impedance matching circuit) 724. The resonance circuit 72 is connected to the communication antenna 10. The resonance circuit 72 has a resonance frequency which is designed to be equal to a frequency of the transmission/reception signal of the communication section 20. Accordingly, the voltage of the reception signal received by the communication antenna 10 is amplified by the resonance circuit 72.

The resonance circuit 72 is connected to the terminals 212 and 214 of the communication section 20 via the first matching circuit 722 and the switch 30. In addition, the resonance circuit 72 is connected to the terminals 222 and 224 of the communication section 20 via the second matching circuit 724 and the switch 30. In general, impedance at each of the terminals 212 and 214 is lower than impedance at each of the terminals 222 and 224. According to the present embodiment, the first matching circuit 722 matches the impedance at the terminals 212 and 214, and the second matching circuit 724 matches the impedance at the terminals 222 and 224. According to the present embodiment, voltage amplitude at the terminals 212 and 214 is made smaller than voltage amplitude at the terminals 222 and 224.

According to the present embodiment, when the communication antenna 10 receives the signal and the switch 30 electrically connects the communication section 20 with the communication antenna 10, the voltage amplitude at the terminals 212 and 214 of the communication section 20 is smaller than the voltage amplitude at the communication antenna 10. Moreover, when the communication antenna 10 receives the signal and the switch 30 electrically disconnects the communication section 20 from the communication antenna 10, the voltage amplitude at the switch 30 is smaller than the voltage amplitude at the communication antenna 10.

According to the present embodiment, the impedance matching section 70 can lower the voltage applied to the switch 30 to some extent. More specifically, the switch 30 can be prevented from receiving a voltage exceeding the power supply voltage of the high voltage output circuit 44 from the communication antenna 10. Accordingly, even though the switch 30 is formed of the semiconductor switches, the switch 30 is more reliably turned into the OFF-state, and the communication section 20 can be more securely protected.

According to the present embodiment, when an electric power transmission signal which is received by the communication antenna 10 has a frequency different from another frequency of the transmission/reception signal, the frequency of the electric power transmission signal is different from the resonance frequency of the resonance circuit 72. Accordingly, the electric power transmission signal is blocked by the resonance circuit 72 to some extent. The first matching circuit 722 is designed to properly work for the transmission/reception signal having a supposed frequency. Accordingly, the first matching circuit 722 might output the overvoltage when receiving the electric power transmission signal of the frequency different from the supposed frequency. However, even if the first matching circuit 722 outputs the overvoltage, the switch 30 is turned into the OFF-state. As a result, the communication section 20 is electrically disconnected from the first matching circuit 722, and the communication section 20 is protected from the overvoltage.

The communication section 20 according to the present embodiment performs the load modulation communication by switching each of the terminals 222 and 224 between a high-impedance state and a low-impedance state. The second matching circuit 724 might output the overvoltage similar to the first matching circuit 722 when receiving the electric power transmission signal of the frequency different from that of the transmission/reception signal. However, also in this case, the switch 30 is turned into the OFF-state. As a result, the communication section 20 is electrically disconnected from the second matching circuit 724, and the communication section 20 is protected from the overvoltage.

The impedance matching section 70 may have a frequency filter function and/or an impedance conversion function in addition to the aforementioned function, wherein the frequency filter function blocks a target signal, or a signal in a frequency band of the electric power transmission signal, and the impedance conversion function lowers the voltage amplitude of the target signal. The communication section 20 is more securely protected when such protection functions are provided in addition to the protection of the communication section 20 by the switch 30.

According to the present embodiment, the switch 30 (in detail, the semiconductor switch such as the MOSFET in the switch 30) is connected with every one of the terminals 212 and 214 and the terminals 222 and 224. However, if a voltage applied to a specific terminal does not become excessive even upon the reception of the electric power transmission signal, the semiconductor switch for this terminal does not need to be provided.

More specifically, in general, the impedance at each of the terminals 212 and 214 matched by the first matching circuit 722 is lower than the impedance at each of the terminals 222 and 224 matched by the second matching circuit 724. Accordingly, in some cases, the overvoltage is not applied to the terminals 212 and 214 even if the switch 30 is not provided. However, in many cases, the switch 30 needs to protect the terminals 222 and 224 because the impedance at each of the terminals 222 and 224 repeatedly becomes high and low. In such cases, the switch 30 may be connected only with the terminals 222 and 224. By not providing the semiconductor switches for the terminals 212 and 214 but providing the semiconductor switches for the terminals 222 and 224, it is possible to reduce the number of the components of the switch 30 while protecting the communication section 20 from the overvoltage.

As can be seen from the above explanation, the first to seventh embodiments are applicable even to a communication device which does not have the non-contact electric power transmission function. However, the present invention including the first to seventh embodiments is also applicable to a communication device having the non-contact electric power transmission function. Hereafter, explanation is made in further detail about the communication device having the non-contact electric power transmission function.

### Eighth Embodiment

As can be seen from FIGS. 19, 21 and 22, a communication device 1G according to an eighth embodiment of the present invention is a modification of the communication device 1F according to the seventh embodiment. Specifically, the communication device 1G comprises the resonance circuit 72 and the first matching circuit 722 of the impedance matching section 70 while not comprising the second matching circuit 724. In addition, the communication device 1G comprises a rectifier circuit 80 and a load 90 which are not comprised in the communication device 1F. Moreover, the communication device 1G comprises, instead of the switch control section 40D, a switch control section 40G slightly different from the switch control section 40D. The communication device 1G has structure and function similar to those of the communication device 1F except for the aforementioned difference. Hereafter, explanation is mainly made about this difference.

The rectifier circuit 80 is connected between the resonance circuit 72 and the first matching circuit 722. The load 90 is connected to the rectifier circuit 80. In other words, the load 90 is connected to the communication antenna 10 via the rectifier circuit 80 and the resonance circuit 72. The load 90 according to the present embodiment is, for example, a secondary battery. As can be seen from this structure, the signal received in the communication antenna 10 is rectified by the rectifier circuit 80 to be supplied to the load 90 as the electric power. In other words, the communication device 1G has the non-contact electric power transmission function.

The switch control section 40G according to the present embodiment is not directly connected to the signal lines 112 but indirectly connected to the signal lines 112 via the rectifier circuit 80. The switch control section 40G detects the voltage rectified by the rectifier circuit 80 as the rectified voltage (detected voltage). Accordingly, the switch control section 40G does not include an internal rectifier circuit.

According to the present embodiment, the electric power can be transmitted to the load 90 while no electric power reception antenna (not shown) other than the communication antenna 10 is provided. Moreover, the rectifier circuit inside the switch control section 40G can be omitted.

As already explained, the switch control sections according to the first to eighth embodiments detect in advance that the voltage equal to or larger than the overvoltage is to be applied to the communication section 20 when the rectified voltage (detected voltage) is not smaller than the predetermined value and is smaller than the overvoltage. In other words, an advance signal for notifying that the overvoltage is to be applied to the communication section 20 is the detected voltage that is not smaller than the predetermined value and is smaller than the overvoltage. However, such advance signal does not need to be the detected voltage according to the first to eighth embodiments. For example, the advance signal may be an electric power transmission notice signal which is transmitted from an external device (not shown) prior to the electric power transmission.

Moreover, the advance signal may be obtained from a circuit, etc. other than the communication antenna 10. For example, a signal of Bluetooth communication or the like may be used as the advance signal. When a time interval between the communication and the electric power transmission is scheduled, a timing control signal generated by an internal timer (not shown) may be used as the advance signal.

Moreover, the advance signal may be a frequency component of the electric power transmission signal included in the reception signal. Hereafter, explanation is made about a communication device which uses the frequency of the electric power transmission signal as the advance signal under a case where the frequency of the transmission/reception signal of the communication section 20 is different from the frequency of the electric power transmission signal.

### Ninth Embodiment

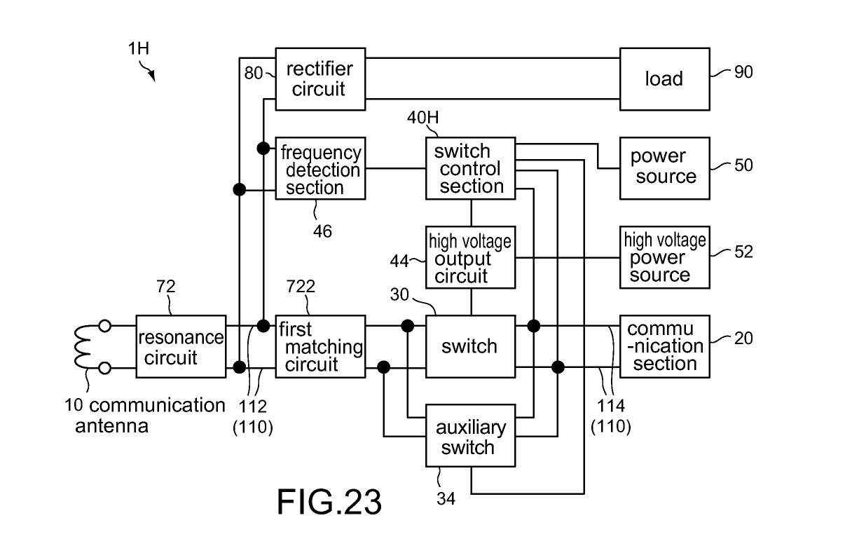

As can be seen from FIGS. 22 and 23, a communication device 1H according to a ninth embodiment of the present invention is a modification of the communication device 1G according to the eighth embodiment. Specifically, the communication device 1H comprises a frequency detection section 46 which is not comprised in the communication device 1G. Moreover, the communication device 1H comprises, instead of the switch control section 40G, a switch control section 40H slightly different from the switch control section 40G. In detail, the switch control section 40H is connected not to the rectifier circuit 80 but to the frequency detection section 46. The communication device 1H has structure and function similar to those of the communication device 1G except for the aforementioned difference. Hereafter, explanation is mainly made about this difference.

The frequency detection section 46 according to the present embodiment is connected to the signal lines 112. Accordingly, the frequency detection section 46 is connected to the communication antenna 10 via the resonance circuit 72. The frequency detection section 46 detects the frequency of the signal on the signal lines 112. If the detected frequency is equal to the frequency of the electric power transmission, the frequency detection section 46 transmits the detected signal to the switch control section 40H. The frequency detection section 46 only needs to detect amplitude of a signal having a specific frequency component, or the frequency of the electric power transmission signal in the present embodiment. For example, the frequency detection section 46 can be formed of a band pass filter or the like.

The switch control section 40H stops the connection command signal directed to the switch 30 and the connection command signal directed to the auxiliary switch 34 when receiving the signal detected by the frequency detection section 46. As a result, the switch 30 and the auxiliary switch 34 electrically disconnect the communication section 20 from the communication antenna 10 to protect the communication section 20. As can be seen from the above explanation, according to the present embodiment, when the signal received by the communication antenna 10 has the frequency same as the frequency of the electric power transmission signal for receiving the electric power in a non-contact manner, the switch control section 40H detects in advance that a voltage equal to or larger than the overvoltage is to be applied to the communication section 20. In other words, the signal that has the frequency same as that of the electric power transmission signal is used as the advance signal which notifies that the overvoltage is to be applied to the communication section 20.

The communication device 1H according to the present embodiment can be variously modified. For example, although the communication device 1H according to the present embodiment is capable of receiving the electric power in a non-contact manner similar to the communication device 1G, the communication device 1H does not need to be capable of receiving the electric power in a non-contact manner. In other words, the communication device 1H does not need to comprise the rectifier circuit 80 and the load 90.

The communication device explained above can be installed in various electronic apparatus. For example, when an electronic apparatus having the non-contact charging function or the like comprises the communication device according to the present invention, the effects of the present invention are more effectively shown. Moreover, the embodiments explained above can be variously combined. For example, the communication device may comprise both the auxiliary switch and the additional switch.

The present application is based on a Japanese patent applications of JP2013-105858 and JP2013-179045 filed before the Japan Patent Office on May 20, 2013 and Aug. 30, 2013, respectively, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

### REFERENCE SIGNS LIST

1, 1A, 1B, 1C, 1D, 1E, 1F, 1G, 1H communication device
10 communication antenna
110 signal line
112 signal line
114 signal line
12 auxiliary antenna
20 communication section
212, 214 terminal (transmission/reception terminal)
222, 224 terminal (load modulation communication terminal)
30 switch
32 additional switch
34 auxiliary switch
40, 40A, 40B, 40C, 40D, 40E, 40G, 40H switch control section
400 reception signal detection section
402 first diode (diode)
42 booster circuit (high voltage output part)
422 second diode (diode)
44 high voltage output circuit (high voltage output part)
46 frequency detection section
50 power source
52 high voltage power source
60 CPU
70 impedance matching section
72 resonance circuit
722 first matching circuit (impedance matching circuit)
724 second matching circuit (impedance matching circuit)
80 rectifier circuit
90 load
C1 capacitor
CA comparator
CB comparator
Q1 MOSFET
Q2 MOSFET
Q3 MOSFET
Q4 MOSFET
Vcc power supply voltage
Vidc rectified voltage

1. A communication device comprising:
a communication antenna;
a communication section which is capable of transmitting and receiving a signal via the communication antenna;
a switch formed of a semiconductor switch and connected between the communication antenna and the communication section, wherein the switch electrically connects the communication section with the communication antenna when receiving a connection command signal, and electrically disconnects the communication section from the communication antenna when not receiving the connection command signal;
a switch control section which outputs the connection command signal toward the switch under a specific condition, wherein the switch control section stops the connection command signal when detecting in advance that an overvoltage is to be applied to the communication section; and
a high voltage output part connected between the switch control section and the switch, wherein the high voltage output part converts a voltage of the connection command signal, which is received from the switch control section and is to be output to the switch, into another voltage that keeps the communication section in a signal transmitting state from being electrically disconnected from the communication antenna.

2. The communication device as recited in claim 1, wherein:
the switch is formed of a MOSFET; and
the connection command signal is output to a gate of the MOSFET of the switch.

3. The communication device as recited in claim 1, wherein:
the switch control section is capable of detecting a detected voltage that is a voltage generated because of signal transmission/reception with use of the communication antenna;
when the detected voltage is not smaller than a predetermined value and smaller than the overvoltage, the switch control section detects in advance that a voltage equal to or larger than the overvoltage is to be applied to the communication section; and
the predetermined value is larger than an upper limit of a voltage that is to be generated because of the signal transmission by the communication section via the communication antenna, and is smaller than the overvoltage.

4. The communication device as recited in claim 3, wherein:
the switch control section is connected to the communication antenna in parallel to the switch; and
the detected voltage is a voltage that is generated in the communication antenna because of the signal transmission/reception with use of the communication antenna.

5. The communication device as recited in claim 3, wherein:
the communication device comprises an auxiliary antenna in addition to the communication antenna;
the switch control section is connected to the auxiliary antenna; and
the detected voltage is a voltage that is generated in the auxiliary antenna because of the signal transmission/reception with use of the communication antenna.

6. The communication device as recited in claim 3, wherein:
the switch control section outputs the connection command signal under a condition where the detected voltage is larger than a first threshold and is not larger than a second threshold;
the switch control section stops the connection command signal under a condition where the detected voltage is not larger than the first threshold or larger than the second threshold;
the first threshold is a lower limit of the detected voltage which is detected when the communication section receives a signal; and
the second threshold is the predetermined value.

7. The communication device as recited in claim 3, wherein:
the switch control section is capable of detecting whether the communication section is in the signal transmitting state or not;
the switch control section outputs the connection command signal under a condition where the detected voltage is larger than a first threshold and is not larger than a second threshold;
the switch control section stops the connection command signal under a condition where the detected voltage is larger than the second threshold;
the switch control section stops the connection command signal under a condition where the communication section is not in the signal transmitting state and the detected voltage is not larger than the first threshold;
the switch control section outputs the connection command signal under a condition where the communication section is in the signal transmitting state and the detected voltage is not larger than the first threshold;
the first threshold is a lower limit of the detected voltage which is detected when the communication section receives a signal; and
the second threshold is the predetermined value.

8. The communication device as recited in claim 6, wherein:
the communication section includes a reception signal detection section; and
the switch control section compares the detected voltage and the first threshold with each other by using the detected voltage which is amplified by the reception signal detection section.

9. The communication device as recited in claim 6, wherein:
the communication device further comprises an additional switch which is formed of a semiconductor switch;
the additional switch is connected between the switch and the communication section;
the additional switch is connected to the switch control section without the high voltage output part;
the switch control section outputs the connection command signal to the additional switch under a condition where the detected voltage is larger than the second threshold;
the switch control section stops the connection command signal directed to the additional switch under a condition where the detected voltage is not larger than the second threshold;
the additional switch electrically connects the communication section with the switch when not receiving the connection command signal; and
the additional switch electrically disconnects the communication section from the switch when receiving the connection command signal.

10. The communication device as recited in claim 9, wherein:
the additional switch is formed of a MOSFET; and
the connection command signal is output to a gate of the MOSFET of the additional switch.

11. The communication device as recited in claim 6, wherein:
the communication device further comprises an auxiliary switch which is formed of a semiconductor switch;
the auxiliary switch is connected between the communication antenna and the communication section in parallel to the switch;
the auxiliary switch is connected to the switch control section without the high voltage output part;
the switch control section outputs the connection command signal to the auxiliary switch under a condition where the detected voltage is not larger than the second threshold;
the switch control section stops the connection command signal directed to the auxiliary switch under a condition where the detected voltage is larger than the second threshold;
when receiving the connection command signal, the auxiliary switch electrically connects the communication section with the communication antenna at least under a condition where the detected voltage is not larger than the first threshold; and
when not receiving the connection command signal, the auxiliary switch electrically disconnects the communication section from the communication antenna.

12. The communication device as recited in claim 11, wherein:
the auxiliary switch is formed of a MOSFET; and
the connection command signal is output to a gate of the MOSFET of the auxiliary switch.

13. The communication device as recited in claim 6, wherein:
the switch control section is connected to the switch without the high voltage output part via a first diode in addition to connection via the high voltage output part;
the high voltage output part is connected to the switch via a second diode other than the first diode;
the switch control section outputs the connection command signal to the switch via the first diode under a condition where the detected voltage is not larger than the second threshold;
the switch control section stops the connection command signal directed to the first diode under a condition where the detected voltage is larger than the second threshold;
the switch electrically connects the communication section with the communication antenna when receiving the connection command signal from one of the first diode and the second diode; and
the switch electrically disconnects the communication section from the communication antenna when not receiving the connection command signal from any one of the first diode and the second diode.

14. The communication device as recited in claim 1, wherein:
the communication device further comprises an impedance matching section; and
the impedance matching section is connected between the communication antenna and the switch.

15. The communication device as recited in claim 14, wherein when the communication antenna receives a signal and the switch electrically connects the communication section with the communication antenna, voltage amplitude in the communication section is smaller than voltage amplitude in the communication antenna.

16. The communication device as recited in claim 15, wherein when the communication antenna receives a signal and the switch electrically disconnects the communication section from the communication antenna, voltage amplitude in the switch is smaller than voltage amplitude in the communication antenna.

17. The communication device as recited in claim 14, wherein the impedance matching section has an impedance matching circuit.

18. The communication device as recited in claim 14, wherein the impedance matching section has a frequency filter function.

19. The communication device as recited in claim 1, wherein:
the communication section has a plurality of transmission/reception terminals for transmitting and receiving a signal, and a plurality of load modulation communication terminals for load modulation communication; and
the switch is connected with every one of the transmission/reception terminals and the load modulation communication terminals.

20. The communication device as recited in claim 1, wherein:
the communication section has a plurality of transmission/reception terminals for transmitting and receiving a signal, and a plurality of load modulation communication terminals for load modulation communication; and
the switch is connected only with the load modulation communication terminals.

21. The communication device as recited in claim 1, wherein when a signal received by the communication antenna has a frequency same as a frequency of an electric power transmission signal for receiving electric power in a non-contact manner, the switch control section detects in advance that a voltage equal to or larger than the overvoltage is to be applied to the communication section.

22. The communication device as recited in claim 1, wherein the communication device further comprises a power source.

23. The communication device as recited in claim 22, wherein the power source is a battery.

24. The communication device as recited in claim 22, wherein:
the high voltage output part is a booster circuit;
the power source is connected to the switch control section; and
the power source supplies operating power to the booster circuit via the switch control section.

25. The communication device as recited in claim 1, wherein:
the communication device further comprises a high voltage power source;
the high voltage output part is a high voltage output circuit which is directly connected to the high voltage power source; and
the high voltage power source supplies operating power to the high voltage output circuit.

26. An electronic apparatus comprising the communication device as recited in claim 1.
